(19) United States
(12) Patent Application Publication
(10) Pub. No.: US 2017/0145594 A1
(43) Pub. Date: May 25, 2017

(54) SPINNING APPARATUS, NOZZLE HEAD AND SPINNING METHOD

(71) Applicant: Kabushiki Kaisha Toshiba, Minato-ku (JP)

(72) Inventors: Kenya UCHIDA, Yokohama (JP); Naoya HAYAMIZU, Yokohama (JP); Ikuo UEMATSU, Yokohama (JP)

(73) Assignee: Kabushiki Kaisha Toshiba, Minato-ku (JP)

(21) Appl. No.: 15/427,589

(22) Filed: Feb. 8, 2017

Related U.S. Application Data
(63) Continuation of application No. PCT/JP2016/053372, filed on Feb. 4, 2016.

(30) Foreign Application Priority Data
Feb. 18, 2015 (JP) 2015-029689

(51) Int. Cl. D01D 5/00; B29C 47/12; B29C 47/92; B29C 47/00

(52) U.S. Cl. CPC D01D 5/0069; B29C 47/0076; B29C 47/0014; B29C 47/12; B29C 47/92; B29C 2791/003; B29C 2947/92704; B29C 2947/92723; B29C 2947/92904

(57) ABSTRACT

According to one embodiment, a spinning apparatus includes a nozzle head, a power generating, and a first atmosphere controller. The nozzle head dispenses a source material liquid from a tip portion toward a collector. The power generating unit generates an electric potential difference between the tip portion and the collector. The first atmosphere controller controls an atmosphere of a first space at a periphery of the nozzle head.

### CROSS-REFERENCE TO RELATED APPLICATIONS

This is a continuation application of International Application PCT/JP2016/053372, filed on Feb. 4, 2016. This application also claims priority to Japanese Application No.2015-029689, filed on Feb. 18, 2015. The entire contents of each are incorporated herein by reference.

### FIELD

Embodiments described herein relate generally to a spinning apparatus, nozzle head and spinning method.

### BACKGROUND

Electrospinning is one method for making an ultrafine fiber such as a microfiber, a nanofiber, etc. In an apparatus that forms the fiber by electrospinning, a voltage is applied to a nozzle head to form nanofiber from polymer solution. There have been cases where electro-discharge occurs in the nozzle head at such a time. Due to such an electro-discharge, there were cases where the voltage and current that are applied to the polymer solution change; the stability of the spinning process is lost; and the spinning process is delayed due to the apparatus stopping, etc.

### BRIEF DESCRIPTION OF THE DRAWINGS

FIG. 1 is a schematic view illustrating a spinning apparatus according to a first embodiment;

FIG. 2A is a cross-sectional view illustrating a nozzle head of the spinning apparatus according to the first embodiment;

FIG. 2B is an enlarged cross-sectional view along line A1-A2 shown in FIG. 2A of the nozzle head of the spinning apparatus according to the first embodiment; and

FIG. 2C is a plan view of the nozzle head;

FIG. 3 is a flowchart illustrating the spinning method of the nanofiber according to the first embodiment;

FIG. 4 is a perspective view illustrating a nozzle head of a spinning apparatus according to a second embodiment;

FIG. 5 is a cross-sectional view along line B1-B2 shown in FIG. 4 of the nozzle head of the spinning apparatus according to the second embodiment;

FIG. 6 is a perspective view illustrating has a nozzle head of a spinning apparatus according to a third embodiment; and

FIG. 7 is an enlarged view corresponding to portion C shown in FIG. 6 of the nozzle head of the spinning apparatus according to the third embodiment.

### DETAILED DESCRIPTION

According to one embodiment, a spinning apparatus includes a nozzle head, a power generating unit, and a first atmosphere controller. The nozzle head dispenses a source material liquid from a tip portion toward a collector. The power generating unit generates an electric potential difference between the tip portion and the collector. The first atmosphere controller controls an atmosphere of a first space at a periphery of the nozzle head.

Various embodiments will be described hereinafter with reference to the accompanying drawings.

The drawings are schematic and conceptual; and the relationships between the thickness and width of portions, the proportions of sizes among portions, etc., are not necessarily the same as the actual values thereof. Further, the dimensions and proportions may be illustrated differently among drawings, even for identical portions.

In the specification and drawings, components similar to those described or illustrated in a drawing thereinabove are marked with like reference numerals, and a detailed description is omitted as appropriate.

### First Embodiment

First, a first embodiment will be described.

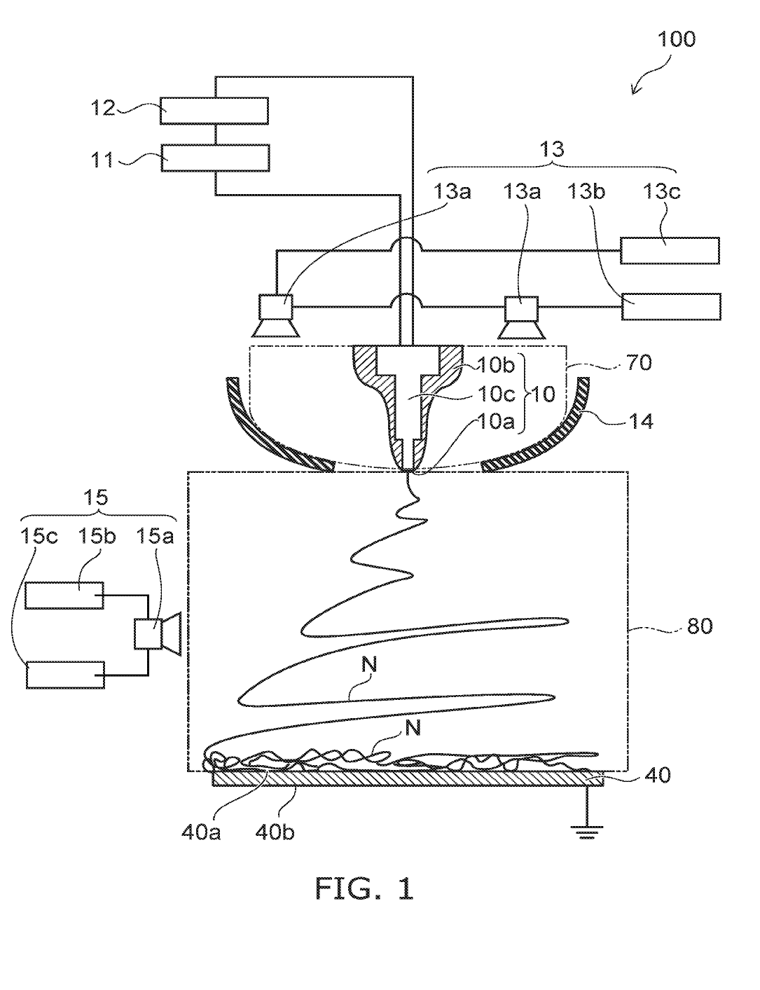

FIG. 1 is a schematic view illustrating a spinning apparatus according to the first embodiment.

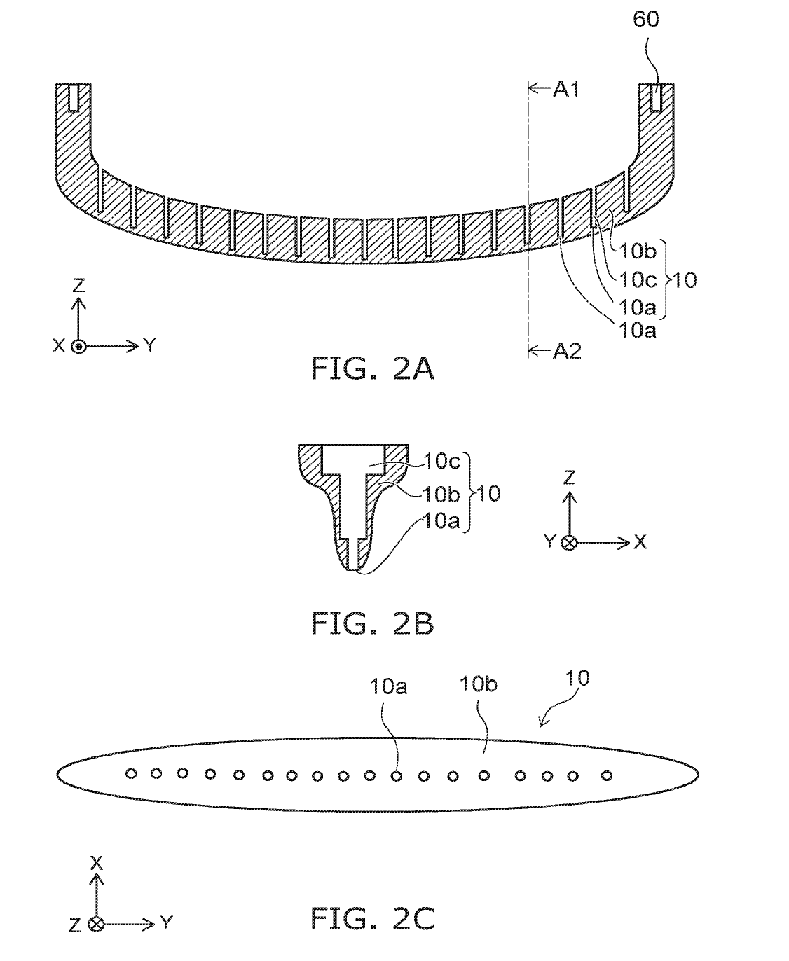

FIG. 2A is a cross-sectional view illustrating a nozzle head of the spinning apparatus according to the first embodiment; B is an enlarged cross-sectional view along line A1-A2 shown in FIG. 2A of the nozzle head of the spinning apparatus according to the first embodiment; and C is a plan view of the nozzle head.

As shown in FIG. 1, a nozzle head 10, a power generating unit 11, a controller 12, a first atmosphere controller 13, an air flow guide 14, and a second atmosphere controller 15 are provided in the spinning apparatus 100 according to the embodiment. The nozzle head 10, the power generating unit 11, and the controller 12 are connected to each other. An outflow port 13a, a gas source 13b, and a controller 13c are provided in the first atmosphere controller 13. An outflow port 15a, a gas source 15b, and a controller 15c are provided in the second atmosphere controller 15.

The nozzle head 10 is a nozzle that dispenses the source material liquid of a nanofiber N such as a liquid in which a macromolecule substance is dissolved, etc. A flow channel 10c for causing the source material liquid to flow through the flow channel 10c is formed inside the nozzle head 10. The end portion of the flow channel 10c communicates with the outside of the nozzle head 10. The portion of the nozzle head 10 where the flow channel 10c communicates with the outside, i.e., the peripheral portion of the boundary line between the outer surface of the nozzle head 10 and the inner surface of the flow channel 10c, is taken as a tip portion 10a; and the portion of the nozzle head 10 other than the tip portion 10a is taken as a main body portion 10b. Thereby, the source material liquid is dispensed from the tip portion 10a via the flow channel 10c.

A collector 40 is mounted in the dispense direction of the source material liquid dispensed from the tip portion 10a. For example, the collector 40 is mounted in a region directly under the nozzle head 10. The collector 40 is a member where the nanofiber N formed by the spinning apparatus 100 is deposited.

The power generating unit 11 is a power generating device that applies a high voltage between the collector 40 and the tip portion 10a of the nozzle head 10. One terminal of the power generating unit 11 is connected to the nozzle head 10; and the other terminal of the power generating unit 11 is grounded. Also, the collector 40 is grounded. By such a connection configuration, an electric potential difference is generated between the tip portion 10a and the collector 40 by operating the power generating unit 11. The collector 40 may not be grounded in the case where the charge of the collector 40 can be neutralized by a charge neutralizer such as an ionizer, etc.

The controller 12 controls the operations of the nozzle head 10 and the power generating unit 11. For example, the controller 12 performs the control of the determination of the voltage value applied to the tip portion 10a, the determination of the amount of the source material liquid to be dispensed, etc. The controller 12 is, for example, a control device such as a computer or the like including a CPU (Central Processing Unit), memory, etc.

The first atmosphere controller 13 generates, from the outflow port 13a, an air flow of which the temperature and humidity are adjusted. As the gas source 13b of the air flow generated from the outflow port 13a, for example, a portion is provided in the first atmosphere controller 13 that generates a gas of which the temperature and humidity are adjusted such as an intake port (not illustrated) that intakes the external air, a temperature/humidity adjuster that adjusts the temperature and humidity of the intaken external air, etc. A cylinder that stores a gas controlled to have a prescribed temperature and a prescribed humidity may be provided as the gas source 13b.

The air flow guide 14 is provided between the collector 40 and the outflow port 13a. The air flow guide 14 guides the air flow generated from the outflow port 13a to a nozzle head peripheral space 70 that is at the nozzle head 10 periphery and is regulated to have a prescribed volume. At this time, the air flow guide 14 shields the flow of the air flow toward a nanofiber manufacturing space 80 shown in FIG. 1 without shielding the source material liquid squirted toward the nanofiber manufacturing space 80 from the tip portion 10a. That is, the air flow guide 14 is not provided in the space between the tip portion 10a and the collector 40 where the source material liquid passes through. Thereby, the air flow guide 14 separates the environment of the nozzle head peripheral space 70 and the environment of the nanofiber manufacturing space 80 without shielding the source material liquid passing through. The nanofiber manufacturing space 80 is regulated to have a prescribed volume in the space on the collector 40.

For example, the air flow guide 14 is formed of an insulating material such as a resin, etc. The air flow guide 14 may not be provided in the case where the air flow generated from the outflow port 13a can reach the nozzle head peripheral space 70 without going through the air flow guide 14.

The second atmosphere controller 15 generates an air flow in which the temperature and humidity are adjusted from the outflow port 15a. As the gas source 15b of the air flow generated from the outflow port 15a, for example, a portion is provided in the second atmosphere controller 15 that generates a gas of which the temperature and humidity are adjusted such as an intake port (not illustrated) that intakes the external air, a temperature/humidity adjuster that adjusts the temperature and humidity of the intaken external air, etc. Or, a cylinder that stores a gas controlled to have a prescribed temperature and a prescribed humidity may be provided as the gas source 15b.

A supply unit that supplies the source material liquid may be provided in the spinning apparatus 100. In such a case, the source material liquid is stored in a tank, etc., provided separately from the tip portion 10a and is supplied from the tank to the tip portion 10a via a pipe. Also, the tip portion 10a and the flow channel 10c may be multiply provided in the nozzle head 10.

For example, a macromolecule resin such as polypropylene, polyethylene, polystyrene, polyethylene terephthalate, polyvinyl alcohol, polyvinyl acetate, etc., or a macromolecule resin of a polymer or the like including these macromolecule resins can be used as the solute of the source material liquid. Also, as the solute, one type selected from the macromolecule resins recited above may be used; or multiple types may be mixed. The invention of the application is not limited to the solutes recited above; and the solutes recited above are examples.

For example, a volatile organic solvent such as isopropanol, ethylene glycol, cyclohexanone, dimethylformamide, acetone, ethyl acetate, etc., or water can be used as the solvent of the source material liquid. Also, as the solvent, one type selected from the solvents recited above may be used; or multiple types may be mixed. The invention of the application is not limited to the solvents recited above; and the solvents recited above are examples.

The collector 40 collects the nanofiber N manufactured in the space between the collector 40 and the nozzle head 10 by the nanofiber N being deposited.

The collector 40 has a first surface 40a and a second surface 40b. The first surface 40a is a surface on a side opposite to the second surface 40b. The nanofiber N is deposited on the first surface 40a of the collector 40. Also, the collector 40 is a conductive member; and an electrode may be provided on the second surface 40b. In such a case, the collector 40 functions as an electrode. An electric potential difference is generated between the source material liquid to which a voltage is applied by the power generating unit 11 and the electrode provided at the second surface 40b; and the source material liquid is guided toward the electrode. Then, the nanofiber N is deposited on the first surface 40a of the collector 40. Also, the charges of the nanofiber N and the collector 40 may be neutralized by a charge neutralizer such as an ionizer, etc. In such a case, an electric potential difference is generated between the collector 40 and the source material liquid to which the voltage is applied by the power generating unit 11; and the source material liquid is guided toward the first surface 40a. Then, the nanofiber N is deposited on the first surface 40a of the collector 40. The charge of the deposited nanofiber N is neutralized by the charge neutralizer.

A case will now be described where multiple tip portions 10a and multiple flow channels 10c are provided in the nozzle head 10.

FIG. 2A is a cross-sectional view illustrating the nozzle head of the spinning apparatus according to the first embodiment; 2B is an enlarged cross-sectional view along line A1-A2 shown in FIG. 2 of the nozzle head of the spinning apparatus according to the first embodiment; and 2C is a plan view of the nozzle head of the spinning apparatus according to the first embodiment.

In the specification hereinbelow, an XYZ orthogonal coordinate system is introduced for convenience of description.

In the nozzle head 10 as shown in FIG. 2A, the tip portions 10a that dispense the source material liquid and the flow channels 10c of the tip portions 10a are multiply provided. When viewed from the X-direction, the configuration of the nozzle head 10 is an arc-like configuration that is convex on the collector 40 side. In such a case, the tip portions 10a are provided on the outer circumferential side of the nozzle head 10 along the Y-direction that is orthogonal to the X-direction. Also, the nozzle head 10 can be fixed at a prescribed position of the spinning apparatus 100 by a support member 60.

The nozzle head 10 is conductive. For example, the nozzle head 10 is formed of a material including a metal such as iron, aluminum, stainless steel, etc.

In the surface of the nozzle head 10 as shown in FIGS. 2A and 2B, the curvature of the protrusion of the surface of the main body portion 10b is smaller than the curvature of the surface of the tip portion 10a.

Also, as shown in FIG. 2C, when viewed from the Z-direction that is orthogonal to the X-direction and the Y-direction, the configuration of the nozzle head 10 is a substantially elliptical configuration having the Y-direction as the longitudinal direction. Although the case is shown in FIGS. 2A and 2C where the tip portions 10a are arranged at uniform spacing in one column, the tip portions 10a may be arranged at any spacing. Also, the tip portions 10a may be provided in two or more columns along the Y-direction.

A spinning method of the nanofiber N according to the embodiment will now be described.

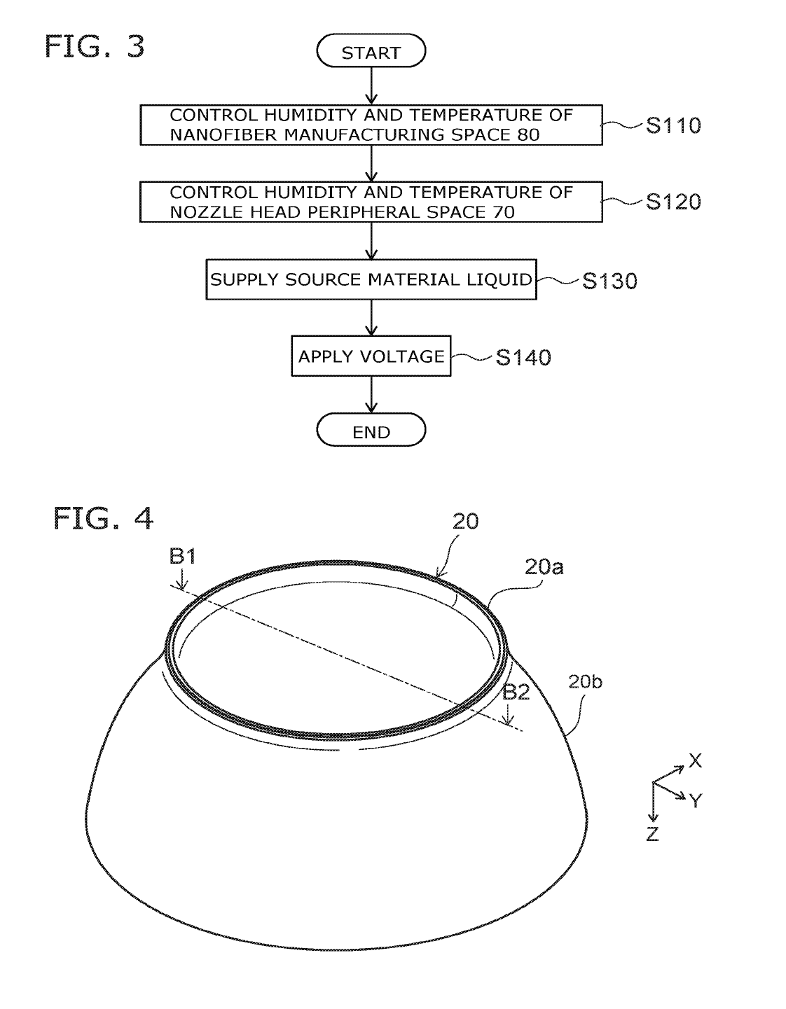

FIG. 3 is a flowchart illustrating the spinning method of the nanofiber according to the first embodiment.

First, the temperature and humidity of the nanofiber manufacturing space 80 shown in FIG. 1 on the collector 40 are controlled by the second atmosphere controller 15 generating an air flow of which the temperature and humidity are adjusted (step S110). Although the water content and temperature of the gas introduced to the nanofiber manufacturing space 80 are different according to the type of the solute and the type of the solvent of the source material liquid that is selected, for example, the atmosphere that is used has a water content between −50° C. and 50° C. by dew point conversion, and a temperature between 10° C. and 70° C. More favorably, the case is favorable where the water content is between −20° C. and 10° C. by dew point conversion, and the temperature is between 30° C. and 60° C.

Also, the temperature and humidity of the nozzle head peripheral space 70 are controlled by the first atmosphere controller 13 generating an air flow of which the temperature and humidity are adjusted (step S120). Although the water content and temperature of the gas introduced to the nozzle head peripheral space 70 are different according to the type of the solute and the type of the solvent of the source material liquid that is selected, for example, the atmosphere that is used has a water content between −50° C. and 50° C. by dew point conversion, and a temperature between 10° C. and 70° C. More favorably, the case is favorable where the water content is between −20° C. and 10° C. by dew point conversion, and the temperature is between 30° C. and 60° C. Also, there are also cases where it is favorable for the humidity of the gas introduced to the nozzle head peripheral space 70 to be lower than the humidity of the nanofiber manufacturing space 80. In such a case, the air flow that is generated from the first atmosphere controller 13 is guided into the nozzle head peripheral space 70 via the air flow guide 14. Also, the environment of the nozzle head peripheral space 70 and the environment of the nanofiber manufacturing space 80 are separated by the air flow guide 14.

Then, the source material liquid is supplied to the tip portion 10a via the flow channel 10c (step S130). Then, the source material liquid is held in the tip portion 10a.

Then, a voltage is applied between the tip portion 10a and the collector 40 by the power generating unit 11 (step S140). When the electrostatic force becomes larger than the surface tension due to the application of the high voltage, the source material liquid is dispensed from the tip portion 10a of the nozzle head 10. The source material liquid that is dispensed from the tip portion 10a is squirted continuously from the tip portion 10a toward the collector 40.

The nanofiber N is formed on the collector 40 by the squirted source material liquid being elongated electrically inside the space.

Subsequently, the nanofiber N that is manufactured between the tip portion 10a and the collector 40 is deposited on the collector 40. By the spinning apparatus 100 of the embodiment, the nanofiber N that has a configuration having a smooth surface, a porous surface, a bead configuration, a core-sheath configuration, a hollow configuration, an ultrafine fiber, or the like is deposited on the collector 40. Step S110 and step S120 may be implemented in the reverse order or may be implemented simultaneously.

The setup for dispensing the source material liquid from the tip portion 10a of the embodiment will now be described. When the high voltage is applied to the nozzle head 10 and the electric potential difference is generated between the nozzle head 10 and the collector 40, ions that have charge of the same polarity as the polarity of the high voltage applied to the nozzle collect at the surface of the source material liquid adhered to the tip portion 10a of the nozzle head 10. The source material liquid protrudes in a hemispherical configuration at the tip portion 10a of the nozzle head 10 due to the interaction between the charge of the surface of the source material liquid and the electric field generated by the voltage applied to the nozzle head 10. Thus, the configuration of the source material liquid protruding in the hemispherical configuration generally is called a Taylor cone (Taylor-Cone).

When the strength of the electric field exceeds the critical value, the electrostatic repulsion force of the charge stored in the source material liquid exceeds the surface tension of the source material liquid; and a portion of the source material liquid is emitted from the Taylor cone. Thereby, the source material liquid is squirted continuously from the tip portion 10a toward the collector 40.

Effects of the embodiment will now be described.

When the voltage is applied to the nozzle head 10, electro-discharge may occur according to the conditions of the temperature and humidity of the nozzle head 10 periphery. Also, in the case where there is an acute angle portion other than the tip portion 10a in the nozzle head 10, corona discharge may occur due to charge concentrating at the acute angle portion.

According to the embodiment, the occurrence of the electro-discharge of the nozzle head 10 can be suppressed by the nozzle head peripheral space 70 of the nozzle head 10 periphery being adjusted to the prescribed temperature and the prescribed humidity by the first atmosphere controller 13.

The collector 40 may be a member having a sheet configuration. Further, in the case where the collector 40 is a member having a sheet configuration, the nanofiber N may be deposited and collected in a state in which the collector 40 is wound onto a roll, etc.

The collector 40 may be, for example, a movable member such as a rotating drum, a belt conveyor, etc.

Also, as shown in FIGS. 2A to 2C, in the nozzle head 10 of the spinning apparatus 100 according to the embodiment, the curvature of the protrusion of the surface of the main body portion 10b is smaller than the curvature of the surface of the tip portion 10a. Thereby, the occurrence of the corona discharge at protrusions other than the tip portion 10a is suppressed.

When the electro-discharge occurs in a general spinning apparatus, there are cases where a safety device operates and the spinning apparatus is stopped. Accordingly, the manufacturing efficiency of the nanofiber N is increased by suppressing the occurrence of the electro-discharge. Also, by causing the electro-discharge to occur less easily, the operating conditions are widened; and the manufacturing of the nanofiber N becomes easy.

Further, by the temperature and humidity of the nanofiber manufacturing space 80 being adjusted by the second atmosphere controller 15, the state of the nanofiber manufacturing space 80 can be a state suited to forming the nanofiber N. Thereby, the manufacturing efficiency of the nanofiber N and the stability of the manufacturing processes increase.

In the embodiment, by the first atmosphere controller 13 and the second atmosphere controller 15, the temperature and humidity can be adjusted to different optimal conditions for the nozzle head peripheral space 70 and the nanofiber manufacturing space 80.

Also, the ambient air may be used as the atmosphere of the nozzle head peripheral space 70; and the atmosphere of the nanofiber manufacturing space 80 may be adjusted by the second atmosphere controller 15. In such a case, the first atmosphere controller 13 may not be provided. Further, the temperature and humidity of the nanofiber manufacturing space 80 may be adjusted by the second atmosphere controller 15; and on the other hand, the ambient air may be introduced as an air flow to the nozzle head peripheral space 70 by the first atmosphere controller 13. Thereby, when the atmosphere of the nanofiber manufacturing space 80 has conditions that induce electro-discharge in the nozzle head peripheral space, the effects from the nanofiber manufacturing space 80 can be suppressed by introducing the ambient air to the nozzle head peripheral space 70. In the case where the first atmosphere controller 13 uses the ambient air to adjust the atmosphere of the nozzle head peripheral space 70, the temperature/humidity adjuster may not be provided in the gas source 13b.

### Second Embodiment

A second embodiment will now be described.

FIG. 4 is a perspective view illustrating a nozzle head of a spinning apparatus according to the second embodiment.

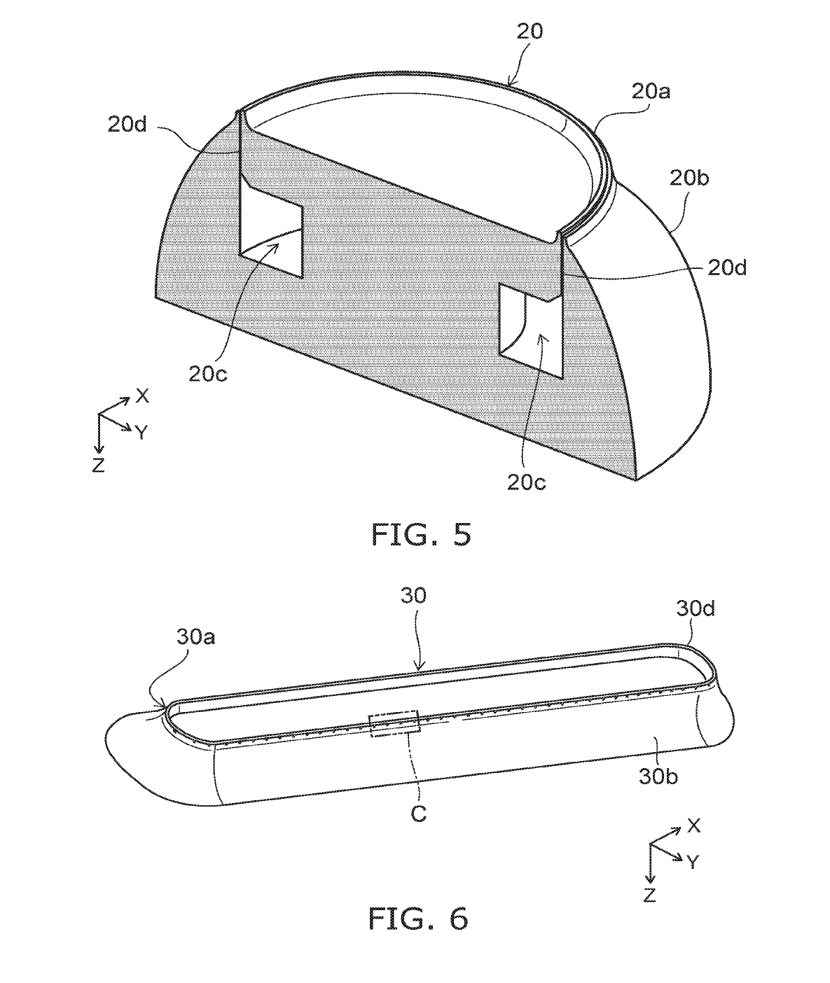

FIG. 5 is a cross-sectional view along line B1-B2 shown in FIG. 4 of the nozzle head of the spinning apparatus according to the second embodiment.

As shown in FIG. 4 and FIG. 5, a flow channel 20c for causing the source material liquid to flow through the flow channel 20c is formed in the nozzle head 20 of the spinning apparatus according to the embodiment. The end portion of the flow channel 20c communicates with the outside of the nozzle head 20. The portion of the nozzle head 20 where the flow channel 20c communicates with the outside, i.e., the peripheral portion of the boundary line between the outer surface of the nozzle head 20 and the inner surface of the flow channel 20c, is taken as a tip portion 20a; and the portion of the nozzle head 20 other than the tip portion 20a is taken as a main body portion 20b. In the nozzle head 20, the exterior form of the main body portion 20b is, for example, a substantially truncated circular conical configuration; and the tip portion 20a is formed at the lower surface of the main body portion 20b. The flow channel 20c is formed in the interior of the nozzle head 20. The configuration of the flow channel 20c is, for example, the configuration of a substantially ring-like configuration or a substantially elliptical ring configuration when projected onto the XY plane perpendicular to a direction (the Z-direction) from the tip portion 20a toward the main body portion 20b. The source material liquid is supplied to the flow channel 20c from a supply unit (not illustrated).

The nozzle head 20 is conductive. The nozzle head 20 includes, for example, a material such as iron, aluminum, stainless steel, etc.

A gap 20d that communicates with the flow channel 20c from the tip portion 20a is formed in the nozzle head 20. The configuration of the gap 20d is, for example, the configuration of a substantially ring-like configuration or a substantially elliptical ring configuration when projected onto the XY plane.

In the surface of the nozzle head 20 as shown in FIG. 4 and FIG. 5, the curvature of the protrusion of the surface of the main body portion 20b is smaller than the curvature of the surface of the tip portion 20a.

Other than the configuration of the nozzle head 20, the spinning apparatus according to the embodiment is similar to the first embodiment described above.

The setup for dispensing the source material liquid from the tip portion 20a of the embodiment will now be described. In the case where a voltage is not applied to the nozzle head 20 by the power generating unit 11, the source material liquid is held by surface tension in the gap 20d of the nozzle head 20. When a voltage is applied between the nozzle head 20 and the collector 40, the source material liquid that is held in the gap 20d is charged to be positive (or negative) and is attracted by the electrostatic force acting along the lines of electric force toward the collector 40 which is grounded.

When the electrostatic force becomes larger than the surface tension, the source material liquid is dispensed from the tip portion 20a of the nozzle head 20. The source material liquid that is dispensed from the tip portion 20a is squirted continuously along the configuration (e.g., the substantially ring-like configuration) of the tip portion 20a from the tip portion 20a toward the collector 40. At this time, the solvent that is included in the source material liquid volatilizes; and a fibrous body of the polymer is deposited on the collector 40 while making a helical path with respect to the direction from the tip portion 20a toward the collector 40.

Effects of the embodiment will now be described.

According to the embodiment, the occurrence of the electro-discharge in the nozzle head 20 can be suppressed by the nozzle head peripheral space 70 of the nozzle head 20 periphery being adjusted to the prescribed temperature and the prescribed humidity by the first atmosphere controller 13.

Also, as shown in FIG. 4 and FIG. 5, in the surface of the nozzle head 20, the curvature of the protrusion of the surface of the main body portion 20b is smaller than the curvature of the surface of the tip portion 20a. Thereby, the occurrence of the corona discharge at protrusions other than the tip portion 20a is suppressed.

Further, by the temperature and humidity of the nanofiber manufacturing space 80 being adjusted by the second atmosphere controller 15, the state of the nanofiber manufacturing space 80 can be a state suited to forming the nanofiber N. Thereby, the manufacturing efficiency of the nanofiber N and the stability of the manufacturing processes increase.

Further, in the spinning apparatus according to the embodiment, the nozzle head 20 includes the tip portion 20a having the substantially ring-like configuration or the substantially elliptical ring configuration. In such a case, the production efficiency of the nanofiber N is higher compared to a nozzle head that includes a singular or multiple holes at the tip portion.

### Third Embodiment

A third embodiment will now be described.

FIG. 6 is a perspective view illustrating has a nozzle head of a spinning apparatus according to the third embodiment.

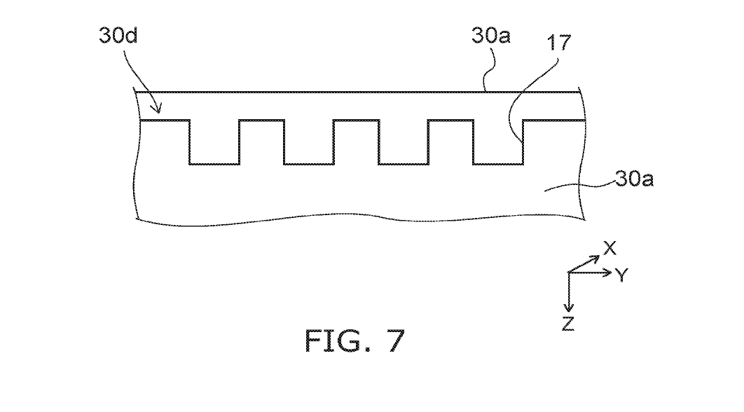

FIG. 7 is an enlarged view corresponding to portion C shown in FIG. 6 of the nozzle head of the spinning apparatus according to the third embodiment.

As shown in FIG. 6, the nozzle head 30 of the spinning apparatus according to the embodiment includes a main body portion 30b and a tip portion 30a dispensing the source material liquid. The configuration of the tip portion 30a is, for example, when projected onto a plane perpendicular to a direction (the Z-direction) from the tip portion 30a toward the main body, a configuration in which the end portions of one of two substantially circular arcs and the end portions of the other substantially circular arc are linked to each other by straight lines. That is, when projected onto a plane perpendicular to the Z-direction, the tip portion 30a has an oval-like configuration including portions having substantially circular arc-like configurations and portions having straight line configurations.

The nozzle head 30 is conductive. For example, the nozzle head 30 is formed of a material including a metal such as iron, aluminum, stainless steel, etc.

A gap 30d is formed in the tip portion 30a of the nozzle head 30. The configuration of the gap 30d is, for example, when projected onto the XY plane perpendicular to a direction (the Z-direction) from the tip portion 30a toward the main body portion 30b, a configuration in which the end portions of one of two substantially circular arcs and the end portions of the other substantially circular arc are linked to each other by straight lines. That is, the gap 30d has an oval-like configuration including portions having substantially circular arc-like configurations and portions having straight line configurations. The source material liquid that is supplied from the supply unit is dispensed from the tip portion 30a via the gap 30d.

Also, in the surface of the nozzle head 30, the curvature of the protrusion of the surface of the main body portion 30b is smaller than the curvature of the surface of the tip portion 30a.

Also, as shown in FIG. 7, recesses 17 may be formed in the side wall of the tip portion 30a. Although the case is shown in FIG. 7 where the recesses 17 are provided on the outer wall side of the gap 30d, the recesses 17 may be provided on the inner wall side or both the inner wall side and the outer wall side of the gap 30d.

The configuration of the spinning apparatus according to the embodiment other than the configuration of the nozzle head 30 is similar to that of the second embodiment described above.

Effects of the embodiment will now be described.

According to the embodiment, the occurrence of the electro-discharge in the nozzle head 30 can be suppressed by the nozzle head peripheral space 70 being adjusted to the prescribed temperature and the prescribed humidity by the first atmosphere controller 13.

Also, in the surface of the nozzle head 30, the curvature of the protrusion of the surface of the main body portion 30b is smaller than the curvature of the surface of the tip portion 30a. Thereby, the occurrence of the corona discharge at protrusions other than the tip portion 30a is suppressed.

Further, by the temperature and humidity of the nanofiber manufacturing space 80 being adjusted by the second atmosphere controller 15, the state of the nanofiber manufacturing space 80 can be a state suited to the formation of the nanofiber N. Thereby, the stability of the spinning process increases.

Further, as shown in FIG. 7, the recesses 17 are provided in the tip portion 30a of the nozzle head 30. Thereby, the source material liquid is held more easily by the gap 30d; and the stability of the spinning process increases.

Further, a portion of the tip portion 30a of the nozzle head 30 is formed in a substantially circular arc-like configuration. By such a configuration of the tip portion 30a, it is easier to deposit the nanofiber N uniformly on the collector 40.

Although the case is described as an example in the third embodiment described above where the tip portion 30a has an oval-like configuration, the configuration may be a straight line configuration. Also, although the case is described in the embodiments described above where the second atmosphere controller 15 is provided, the second atmosphere controller 15 may not be provided. In such a case, the ambient air may be used as the atmosphere of the nanofiber manufacturing space 80.

The embodiments may include following constitutions.

### (Constitution 1)

A spinning apparatus, comprising:
a nozzle head dispensing a source material liquid from a tip portion toward a collector;
a power generating unit generating an electric potential difference between the tip portion and the collector; and
a first atmosphere controller controlling an atmosphere of a first space at a periphery of the nozzle head.

### (Constitution 2)

The spinning apparatus according to constitution 1, wherein the first atmosphere controller generates an air flow, the air flow having humidity that is adjusted.

### (Constitution 3)

The spinning apparatus according to constitution 2, wherein the humidity of the air flow is lower than a humidity of a periphery of the collector.

### (Constitution 4)

The spinning apparatus according to constitution 2 or constitution 3, wherein the first atmosphere controller adjusts a temperature of the air flow.

### (Constitution 5)

The spinning apparatus according to constitution 1 to constitution 4, further comprising a second atmosphere controller controlling an atmosphere of a second space, the second space being above the collector and being other than the first space.

### (Constitution 6)

The spinning apparatus according to constitution 2 to constitution 5, further comprising an air flow guide guiding the air flow generated from the first atmosphere controller into the first space.

### (Constitution 7)

The spinning apparatus according to constitution 6, wherein the air flow guide is disposed between the collector and an outflow port of the air flow of the first atmosphere controller.

### (Constitution 8)

A spinning apparatus, comprising:
a nozzle head dispensing a source material liquid from a tip portion toward a collector;
a power generating unit generating an electric potential difference between the tip portion and the collector; and
a second atmosphere controller controlling an atmosphere of a second space, the second space being above the collector.

### (Constitution 9)

The spinning apparatus according to constitution 1 to constitution 8, wherein a curvature of a protrusion of a surface of a main body portion of the nozzle head is smaller than a curvature of a surface of the tip portion.

### (Constitution 10)

A nozzle head, comprising:
a main body portion, a flow channel being formed in an interior of the main body portion; and
a tip portion where the flow channel communicates with the outside,
a curvature of a protrusion of a surface of the main body portion being smaller than a curvature of a surface of the tip portion.

### (Constitution 11)

A spinning method, comprising depositing a fiber on a collector by controlling an atmosphere of a periphery of a nozzle head and by dispensing a source material liquid from a tip portion of the nozzle head while applying a voltage between the tip portion and the collector.

According to the embodiments described above, a spinning apparatus, a nozzle head, and a spinning method in which the stability of the spinning process can be realized.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Additionally, the embodiments described above can be combined mutually.

What is claimed is:

1. A spinning apparatus, comprising:
a nozzle head dispensing a source material liquid from a tip portion toward a collector;
a power generating unit generating an electric potential difference between the tip portion and the collector; and
a first atmosphere controller controlling an atmosphere of a first space at a periphery of the nozzle head.

2. The spinning apparatus according to claim 1, wherein the first atmosphere controller generates an air flow, the air flow having humidity that is adjusted.

3. The spinning apparatus according to claim 2, wherein the humidity of the air flow is lower than a humidity of a periphery of the collector.

4. The spinning apparatus according to claim 2, wherein the first atmosphere controller adjusts a temperature of the air flow.

5. The spinning apparatus according to claim 1, further comprising a second atmosphere controller controlling an atmosphere of a second space, the second space being above the collector and being other than the first space.

6. The spinning apparatus according to claim 2, further comprising an air flow guide guiding the air flow generated from the first atmosphere controller into the first space.

7. The spinning apparatus according to claim 6, wherein the air flow guide is disposed between the collector and an outflow port of the air flow of the first atmosphere controller.

8. The spinning apparatus according to claim 1, wherein a curvature of a protrusion of a surface of a main body portion of the nozzle head is smaller than a curvature of a surface of the tip portion.

9. A spinning apparatus, comprising:
a nozzle head dispensing a source material liquid from a tip portion toward a collector;
a power generating unit generating an electric potential difference between the tip portion and the collector; and
a second atmosphere controller controlling an atmosphere of a second space, the second space being above the collector.

10. The spinning apparatus according to claim 9, wherein a curvature of a protrusion of a surface of a main body portion of the nozzle head is smaller than a curvature of a surface of the tip portion.

11. A nozzle head, comprising:
a main body portion, a flow channel being formed in an interior of the main body portion; and
a tip portion where the flow channel communicates with the outside,
a curvature of a protrusion of a surface of the main body portion being smaller than a curvature of a surface of the tip portion.
